(19) United States
(12) Patent Application Publication
(10) Pub. No.: US 2010/0106467 A1
(43) Pub. Date: Apr. 29, 2010

(54) System and method for simulating and modeling the distribution of discrete systems

(76) Inventor: Menwer Attarakih Attarakih, Kaiseslautern (DE)

Correspondence Address: LAW OFFICE OF MARTIN JERISAT, Suite 3300, 10 S. LaSalle Street, CHICAGO, IL, 60603, US

(21) Appl. No.: 12/220,070

(22) Filed: Jul. 21, 2008

Related U.S. Application Data
(60) Provisional application No. 60/961,273, filed on Jul. 20, 2007.

(51) Int. Cl. G06F 17/17; G06G 7/48

(52) U.S. Cl. 703/2; 703/6

(57) ABSTRACT

A system and method are introduced for simulating the particulate physical systems governed by population balance equations with particle splitting (breakage) and aggregation based on accurately conserving an unlimited number of moments associated with the particle size distribution. The basic idea is based on the concept of primary and secondary particles, where the former is responsible for the distribution reconstruction while the latter one is responsible for different particle interactions such as splitting and aggregation. The system and method are found to track accurately any set of low-order moments with the ability to reconstruct the shape of the distribution.

### CLAIM OF PRIORITY

The present application claims priority to a U.S. provisional application filed on Jul. 20, 2008, with Ser. No. 60/961,273, which is hereby expressly incorporated herein by reference.

### BACKGROUND

1. Field

The invention relates generally to the field of mathematical modeling of population balance and more particularly to the modeling of discrete systems.

2. Background of the Invention

The population balance equation (PBE) forms nowadays the cornerstone for modeling polydispersed (discrete) systems arising in many engineering applications such as aerosols dynamics, nanoparticle generation, crystallization, precipitation, mining (granulation), liquid-liquid (liquid-liquid extraction (physical and reactive)), emulsion polymerization, activated sludge flocculation), gas-liquid (bubble column reactors, bioreactors, nucleate boiling, evaporation, condensation), gas-solid (fluidized bed reactors), combustion processes (turbulent flame reactors) and microbial systems (multi-variable cell population).

The population balance modeling lays down a modern approach for modeling the complex behavior of such systems. This complex behavior is in part a consequence of the multiscale processes that take place. For example the particle forces are strongly dependent on the shape and size of the particles which can affect the terminal velocity.

For this reason, the modeling of the particle size distribution can bring new possibilities for getting more accurate prediction of polydispersed systems behavior. In this way, the PBE can be used for improving the modeling of two phase flow problems.

The dispersed phase is modeled in terms of a density function. The evolution of this density function is dictated by the different active mechanisms involved such as breakage, coalescence, growth, and so on. The accurate prediction of the dispersed phase evolution depends strongly on the proper modeling of the different processes including the continuous flow field in which the particles are dispersed.

The challenges in modeling these processes are due to the discrete nature of particles whose states are not only affected by the particle-particle interactions, but also due to interaction of these particles with their continuous environment. The results of these interactions lead to different active mechanisms such as particle breakage, attrition, aggregation (coalescence), growth and nucleation. The resulting model equations of these mechanisms range from integro-differential to integro-partial differential equations with no general analytical solutions. As a result of this, the numerical solution of which has been an active area of research for the last three decades. However, most numerical methods have focused on the specifics of the problem of interest.

Accordingly, there exist in the literature many numerical methods as attempts to solve certain type of the PBEs. These methods range from simple finite difference schemes (FDS) or sectional methods using linear grids (in terms of particle diameters) to Galerkin and orthogonal collocations methods on finite elements.

In the FDS the particle population is discretized into a finite number of intervals that are used to track the population density directly. The FDS are particularly useful when the particle sizes do not vary widely. On the other hand, one limitation of the finite difference schemes is their inability to predict accurately integral quantities (low-order moments as a especial case) associated with populations of sharp shapes.

The quadrature method of moments (QMOM) was introduced to solve the PBE with pure growth is found very efficient from accuracy and computational cost point of view. Unlike the FDS (sectional) methods, the QMOM has a drawback of destroying the shape of the distribution and retain information about it only through that stored in its moments. The kth moment is defined by integrating the population number density function with respect to certain population property (e.g. particle sizes) weighted with this property raised to its kth power. When k equals zero the zero moment represents the total number of particles per unit volume; on the other hand, when k equals three the third moment represents the volume fraction (volume concentration) of the particles. The QMOM tracks the population moments (e.g. the zero and third moments) rather than its size and hence it does not depend on the minimum and maximum particle sizes. A closure problem arises since the integral terms appearing in the PBE could not be written generally in terms of the moments only. This closure is due to the specific forms of the breakage and aggregation frequencies which depend in turn on the type of physical application of the PBE. The QMOM is used here in order to close approximately these integrals by using a Gauss-like quadrature (numerical integration).

The solution for the abscissas (nodes) and weights used in this quadrature requires the solution of an eigenvalue problem in terms of the population low-order moments. These eigenvaluses are roots of a polynomial equation resulting from the approximation of the number density function (integrand) by a polynomial of a specified degree that equals the desired number of low-order moments. Unfortunately, as the number of the low-order moments increases, the solution of the associated eigenvalue problem becomes difficult due to ill-conditioning (increasing of round off errors).

Accordingly, there is a need for a system and method for simulating and modeling the distribution of discrete systems that address the problems of the prior art methods and systems. The method of the present invention is referred to hereafter as the the primary and secondary particle method (“PSPM”).

### SUMMARY OF THE INVENTION

The objects mentioned above, as well as other objects, are solved by the present invention, which overcomes disadvantages while providing new advantages not previously obtainable in the prior art.

According to the present invention, a unified and general numerical approach for a wide class of population balance problems is introduced, which will serve as a valuable computational interface for revealing important similarities in the dynamical behavior of particulate and dispersed phase systems. In general, the method includes the steps of dividing the internal property into a number of units; storing information about the internal property of each unit; generating information about the variation of the internal property in each unit; generating information about the internal property of the population in each unit; and generating information to approximately recover the internal property of the population of the discrete systems.

The idea is based on dividing the particle state (for example the particle size) into arbitrary contiguous partitions. In each partition, the population density function is represented by primary particle carrying sufficient information about the shape of the original distribution. The population in a given partition is allowed to interact with that in the other ones through what it is called the secondary particles. These particles carry enough information about the local variations of the population density function through their local low-order moments. Since the evolution of the population density function in time and its shape are governed by the number of primary and secondary particles, the method according to the present invention is called the primary and secondary particles method (“PSPM”).

The present invention combines the idea of self distribution reconstruction (“FDS”) and the (“QMOM”). However, the difficulty encountered in solving the ill-conditioned eigenvalue problem associated with the QMOM is avoided here by considering small number of secondary particles (small size eigenvalue problem) at the expense of increasing the number of primary particles (increasing the number of sections).

In the following sections, the system and method of the present invention are introduced and thoroughly tested using the available analytical solutions when it is possible. It is found that the system and method of the present invention prove to be very accurate in solving the PBEs, furnish a Gauss-like quadrature to evaluate any integral quantities associated with the population density and converge very fast as the number of primary and secondary particles is increased.

### BRIEF DESCRIPTION OF THE DRAWINGS

The novel features which are characteristic of the invention are set forth in the appended claims. The invention itself however, together with further objects and attendant advantages thereof, will be best understood by reference to the following description taken in connection with the accompanying drawings, in which:

FIG. (1a) illustrates a convergence of the first four moments ( )using the PSPM for particle breakage in continuous stirred vessel by varying the number of primary particles(Ms);

FIG. (1b) illustrates a convergence by varying the number of secondary particles (Nq);

FIG. (2a) illustrates a comparison between the analytical solution and that predicted by the PSPM for particle breakage in continuous stirred vessel;

FIG. (2b) illustrates a convergence of the PSPM in terms of the systematic error in d30 (d3032 μ₃/μ₀);

FIG. (3) illustrates a comparison between the FDS (CDA: Conservative Discretization Approach) solution and that predicted by the PSPM method of the present invention for particle breakage in continuous stirred vessel with realized breakage functions;

FIG. (4a) illustrates a comparison between the analytical and predicted solutions using the PSPM method of the present invention for particle aggregation in batch stirred vessel (d₀=1, N₀=1); and

FIG. (4b) shows the effect of primary and secondary particles of the present invention on the CPU requirement.

### DETAILED DESCRIPTION

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

The population balance equation describing particles splitting, aggregation, entering and leaving a fixed homogeneous subspace may be represented as:

$$\{ Rate of accumulation of number of particles per unit volume \} = \{ Rate of number of particles flowing in through boundary \} - \{ Rate of number of particles flowing out through boundary \} + \{ Rate of particles born due to particle aggregation \} - \{ Rate of particles died due to particle aggregation \} + \{ Rate of particles born due to particle splitting \} - \{ Rate of particles died due to particle splitting \}$$

Since the particles are assumed to have in general a spectrum of sizes, this spectrum could be represented by a number density function with particle size as an independent variable. So, let f(v,t) be the average number of particles per unit volume of a fixed subspace at time t, then the above number continuity equation is formally interpreted as: The first term on the left hand side denotes the rate of accumulation of particles of size v. The first term on the right hand side is the net rate of particles due to entry and exit events. The source term (due to splitting and aggregation) is rather complex and consists of two parts: The formation term (preceded by plus sign) and loss term (preceded by minus sign).

The splitting and aggregation of particles are governed by splitting and aggregation frequencies respectively. The splitting frequency represents the fraction of particles splitting per unit time, while the aggregation frequency accounts for the probability of successful collisions between a pair of particles.

Splitting frequency: to complete the description of particle splitting, models for splitting frequency as well as the daughter particle distribution should be completely defined. Unfortunately, these models are problem dependent and hence could not be generally defined without resource to the equipment geometry.

As an example, for droplet splitting in liquid-liquid dispersions, it is experimentally observed that the droplet splitting is mainly determined by the action of the shearing force resulting from the rotating discs. On the other hand, particle splitting during granulation is governed by the high shear forces during collision of particles with each other, the wall or impeller.

Nevertheless, the splitting frequency is usually proportional to the particle size and is a function of the continuous environment physical properties (mainly the surface tension), particle residence time, and the energy input. The daughter particle distribution is usually correlated using a certain type of the β-distribution.

Aggregation frequency: aggregation (coalescence) results from the successful collision between at least two particles to produce a new composite particle. In general, the particle aggregation is more complex than the particle splitting since it involves the interaction between two particles and the intervening film from the continuous environment in case of liquid and gas bubbles.

For solid particles, the success of collisions could be a function of binder and powder physical properties, particle size and operational factors such as powder velocity and bed height. The aggregation frequency is usually correlated as a product of collision rate and coalescence efficiency based on the kinetic theory of gases with two fitting parameters.

The (PSPM) of the present invention may include the following steps:
1. The domain of the particle internal coordinate (here taken as a particle size), Ω_{d} , may be assumed to be bounded due to the regulatory conditions placed upon the homogeneous (with respect to the physical space) population density function. This means that the particle density function has to vanish below minimum and maximum particle sizes.
2. The finite domain of the particle internal coordinate as defined in (1) may be partitioned into a finite number of primary particles having positions located in a rational manner in any partition. This position is given by the ratio of the first and zero moments with respect to the particle size in any specified partition. Note that the union of all these partitions results in the particle domain Ω_{d}
3. The shape of the population density function defined in (1) may be approximated by a series of finite primary particles having a local uniform distribution in each partition with a discontinuity jumps at the partition interfaces. Theoretically, the exact number density function may be recovered as the number of these partitions approaches infinity.
4. Each primary particle defined in (3) may be associated with a finite number (N_{q}) of secondary particles that are capable of reflecting the local variation of the particles population density in the given partition and may be responsible at the same time for any particle splitting (breakage) or/and particle aggregation.
5. The secondary particles as described in (4) may have their own local uniform distribution (weights) that may be given by: wⱼ^{<i>}, j=1, 2, . . . N_{q} and local positions (abscissas): dⱼ^{<i>}, j=1, 2, . . . N_{q}.
6. The primary particle local uniform distribution (\tilde{w}ᵢ) may be recovered from the local secondary particle distribution defined in (5) (wⱼ^{<i>}, j=1, 2, . . . N_{q}) by averaging the latter with respect to the given partition width.
7. The primary particle positions, \tilde{d}ᵢi=1, 2, . . . N_{q}, may be found by averaging the local positions of the secondary particles with respect to their local uniform distribution.
8. The rth moment of the distribution in the ith partition may be defined as the integral over the ith partition size of the product of the particle size (raised to the rth power) and the density function (μᵣ^{<i>}, r=0, 1 . . . 2N_{q}−1).
9. The local population uniform distribution and positions of the secondary particles may be obtained by inverting the local moment problem represented by rth moment of the local population uniform distribution. This means that given a set of low-order moments (μᵣ^{<i>}, r=0, 1 . . . 2N_{q}−1), may solve the resulting set of nonlinear equations for the local positions and uniform distribution (weights) of the secondary particles.
10. For the general moment problem described in (8), the product-difference algorithm as may be used to find the secondary particle local uniform distribution (wⱼ^{<i>}, j=1, 2, . . . N_{q}) and positions (dⱼ^{<i>}, j=1, 2, . . . N_{q}).
11. For the special case of two secondary particles (N_{q}=2), the moment problem described in (8) admits an analytical solution for the secondary particles positions and weights, which is uniquely determined in terms of the four low-order moments (μᵣ^{<i>}, r=0, 1, 2, 3) with a set of highly nonlinear equations. These equations describe with a high accuracy the evolution of particle positions and uniform distribution. This accuracy could be increased by merely decreasing the width of the partitions or selectively refining the size of the partitions containing the primary particles. In this way appears the advantage of the PSPM that does not indeed require more than two secondary particles, since the accuracy of the method is increased by only increasing the number of primary particles. This advantage avoids the solution of large highly nonlinear systems (ill-conditioned eigenvalue problems) when the number of primary particles is greater than two particles.
12. The secondary particles may carry detailed information about the number density function through the low-order moments (μᵣ^{<i>}, r=0, 1, . . . 2N_{q}−1). Note that high-order moments provide information only about the tail of the distribution and hence four low-order moments are sufficient to represent locally the distribution.
13. The uniform distribution (weights) and locations of the secondary particles as described in (10 & 11) may provide a Gauss-like quadrature formula for closing any integral associated with the unknown density function. The accuracy of this quadrature may increase by increasing the number of primary particles.
14. Particle splitting (breakage):
   14.1 Any secondary particle associated with the ith primary particle may be amenable to splitting, and if so, it is called a mother particle.
   14.2 The resulting particles from the breakage of the mother particle as described in 13.1 are called the daughter particles with a conditional distribution called the daughter particle distribution. This distribution for a given particle size range may give the probability to find a daughter particle of a specified size given that a breakage of a mother particle has occurred.
   14.3 To conserve correctly the moments of the newly birthed particles associated with the ith primary particle, all the moments (up to 2N_{q}−1) of the birthed particles is taken into account exactly. This may be accomplished by taking the moments of the daughter particle distribution with integration limits as the boundaries of the ith partition. Note that the daughter particle distribution vanishes for any daughter particle size greater than the size of the mother particle, which is consistent with general physical laws of particle breakage.
   14.4 Since for the ith primary particle it is probable to find a newly birthed particle with size, d, contained in the ith partition, it follows that all the particles of size greater than d are possible candidates for splitting and hence the total birth term consists of the sum of all these possible events.
   14.5 The birth term as described in (13.4) in a discrete form represents the summation over all the particles that has already been broken from all the partitions greater than or equal the ith one. This summation takes into account the exact moment conservation of the formed particles by breakage according to the probability of finding such particles in these partitions.
   14.6 Since the death of particles occurs only due to splitting of secondary particles associated with the ith primary particle, the total death of particles may found by summing the contributions of all the secondary particles in this partition.
   14.7 The frequency of particle birth or death at any instant of time is governed by the splitting (breakage) frequency function, which represents the fraction of particles breaking per unit time.
   14.8 The death term by splitting (breakage) is represented by the loss of particles from the ith partition according to the product of splitting frequency and the probability of finding secondary particles in the ith partition. This death, of course, conserves exactly the desired number of low-order moments.
   14.9 The total splitting term due to birth and death as described in (13.5 & 13.8) is the sum of these two terms.
15. Particle Aggregation (coalescence):
   15.1 Any pair of secondary particles may be amenable to aggregation with a frequency function that represents the probability of successful collisions between any two given secondary particles. The aggregation is proportional to the probability of finding these particles in the ith and any lower partition to form a newly birthed secondary particle associated with the ith primary particle.
   15.2 The aggregation event as described in (14.1) may be considered a successful one if the size of the newly birthed particle is contained in the partition size of the ith primary particle.
   15.3 The low-order moments of the newly birthed secondary particle is exactly conserved by equating the low-order moments of the newly birthed particle and the two individual aggregated particles.
   15.4 To avoid counting the aggregation events twice between any two secondary particles of the same size, divide such an event by two.
   15.5 Since all secondary particles having size less than that of any particle belonging to the ith partition are amenable to aggregation, an aggregation interaction matrix is set up to take into account the successful aggregation events. This matrix reduces the computational cost, since it is a sparse matrix with non-zero elements used to occupy the rth moments of the successfully aggregating particles.
   15.6 The total birth of particles by aggregation as described in (14.5) is the sum of all successful aggregation events taken overall the possible pairs of secondary particles up to the ith partition. The summation is facilitated using the aggregation interaction matrix described in (14.5).
   15.7 The total death of particles in the ith partition by aggregation is due to all aggregation events between the secondary particles up to the ith partition and those in all the other partitions. The total death term is written such that it conserves exactly the specified number of low-order moments.
   15.8 The total aggregation term due to birth and death as described in (14.6 & 14.7) is the sum of these two terms.
   15.9 Note that there is no overlapping between the aggregation events in two consecutive partitions; that is; the union of any two adjacent aggregation interaction matrices is empty. Consequently, the union of all the adjacent aggregation interaction matrices is a full and upper triangular matrix consists of all the possible successful aggregation events.
16. The net number of particles per unit volume of physical space generated due to splitting (breakage) and aggregation is the sum of the net number of particles due to splitting (13.9) and these due to aggregation (14.8)
17. The rth moment in any partition i may now evolve in time using an explicit time marching scheme such as the Euler's method starting from an defined initial state.
18. The updated moments at any section i as described in (17) are then used to update the population densities and locations of the secondary particles according to (10) or (11) and the process is repeated.
19. The low-order moments of the whole population may be found by the sum of all the ith moments and the method of the present invention reproduces very accurately these moments.
20. Since the shape of the partition as described in (2) is not fixed, it may be refined as required by the user in order to increase the accuracy of the integration quadrature described in (13).

### Examples

The PSPM described above is applied to the following problems where analytical solution is available for Examples 1 & 3:

### 1. Example 1

### Splitting in a Continuous Stirred Vessel with Simplified Splitting Functions

### 2. Example 2

### Splitting in a Continuous Stirred Vessel with Realized Splitting Functions

### 3. Example 3

### Aggregation in a Batch Vessel

TABLE 1
The PSPM and the other sectional methods

| | No. of | |
|---|---|---|
| | Primary | |
| Sectional Method | particles | No. of Secondary particles |
| Classical sectional | Mₛ | 1 |
| methods | | carries some information |
| | | about w but none about d |
| Fixed-pivot technique | Mₛ | 1 |
| | | carries some information |
| | | about w & but none about d |
| Moving pivot | Mₛ | 1 |
| technique | | carries some information |
| | | about w & d |
| Conservative | Mₛ | carries some information |
| discretization | | about w but none about d |
| QMOM | 1 | N_{q} |
| | | carries detailed information |
| | | about w & d |
| PSPM | Mₛ | N_{q} |
| according to the | | carries detailed information |
| present invention | | about w & d |

The relationship between the PSPM and the other sectional methods is shown in Table 1. It is clear that all the sectional methods reported in this table are only special cases of the PSPM by varying either the number of primary or secondary particles. For example, the moving pivot technique of Kumar and Ramkrishna is recovered by setting the number of secondary particles to one and the number of primary particles to an arbitrary number: Mₛ. However, due to selecting only one secondary particle, the number of low-order moments conserved is two. These are could be selected as the total number and mass of particles.

For the purpose of numerical validation, three examples are presented here for the case of particle (droplet) splitting and aggregation in a well-mixed vessel where the analytical solution for the PBE is available. The local low-order moments in each partition are evolved in time using the trapezoidal rule with fixed step size of 0.1 second.

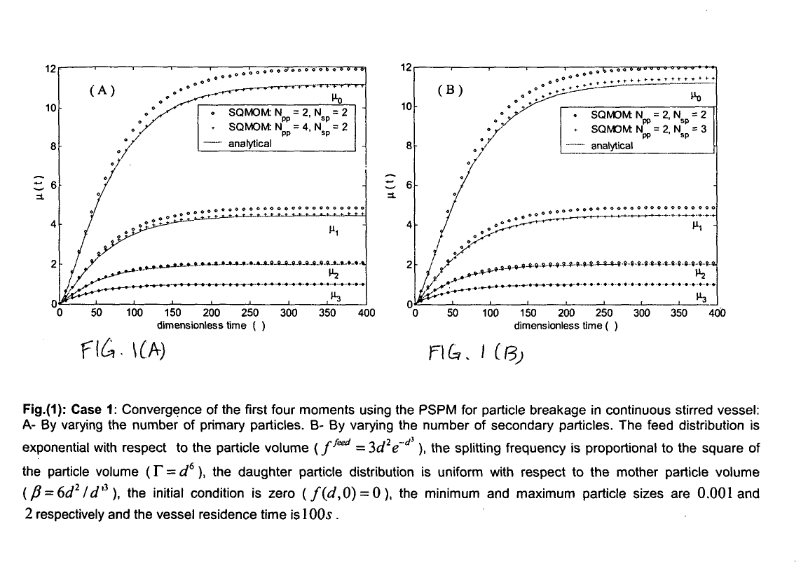

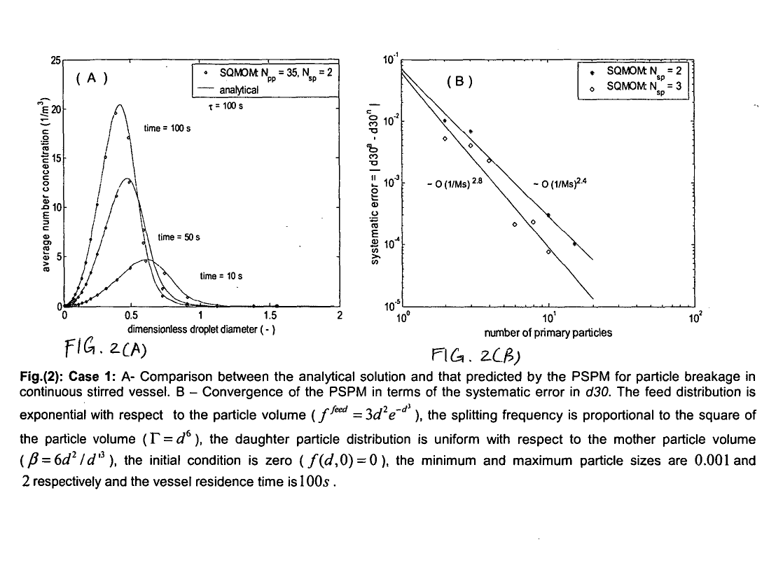

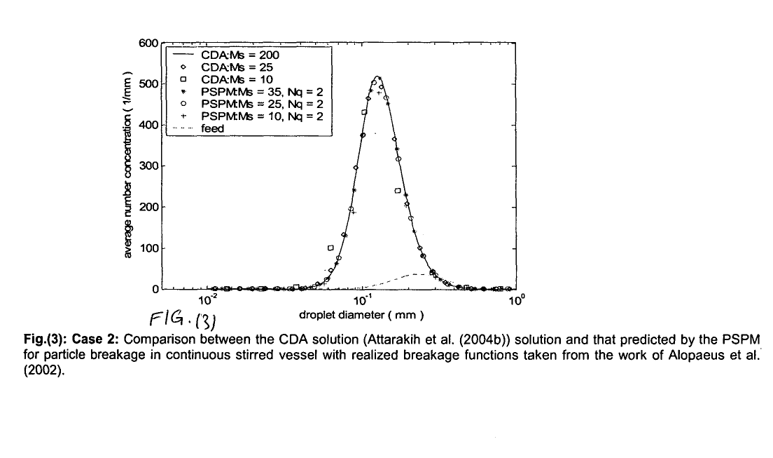

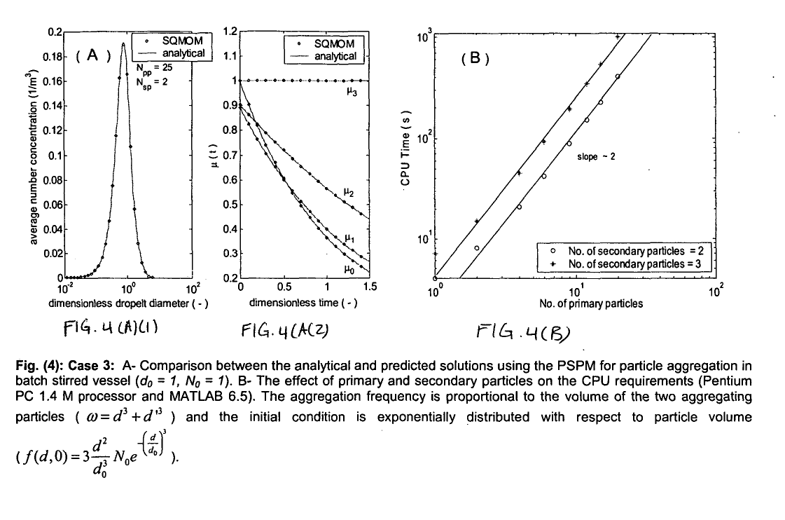

FIG. (1a) compares the convergence of the PSPM at fixed number of secondary particles by varying the number of primary particles from 2 to 4. It is clear how the first two moments (μ₀ & μ₁) are over predicted using only two primary and secondary particles. The inaccuracy is attributed to the sharpness of the distribution as it is evolved in time (see FIG. 2a).

By doubling the number of primary particles or equivalently the number of partitions, the width of each partition is decreased resulting in an accurate integration over the sharp distribution as expected where this fact is true for all Gauss-like quadrature methods. On the other hand, by increasing the number of secondary particles from 2 to 3 as seen in FIG. (1b), the same result is almost obtained, which is expected since the accuracy of the quadrature methods is increased by increasing the number of the quadrature points (secondary particles).

In FIG. (2a), the average number concentration as predicted using the PSPM is compared to the analytical solution at different periods of time. It is clear that using 35 primary particles is enough to follow the shape of the number density function very accurately. However, since the predicted shape of the distribution is not used in the prediction of any integral property, small number of primary particles is found enough to get an idea about the shape of the distribution. Consequently, the location and weights (see the algorithm) of the secondary particles are used to evaluate any integral over the unknown distribution with the desired accuracy.

To get more insight on the convergence properties of the PSPM of the present invention, the systematic error (the absolute difference between the analytical and numerical values) based on the mean particle diameter (d30) is studied as function of the number of primary and secondary particles. It is evident in FIG. (2b) that the speed of convergence is increased by increasing both the primary and secondary particles due to the increasing accuracy of evaluating the unclosed integrals in the PBE.

Note that the dispersion of the errors in FIG. (2b) might be attributed to the numerical errors resulting from the fixed-time step trapezoidal rule. It is noticed that the resulting set of particles' weights and positions are highly nonlinear functions of the low-order moments and numerical integration errors with respect to time could be reduced using higher-order methods such as the 4^{th} Runge Kutta method.

FIG. (3) shows a comparison between the classical conservative descretization approach (CDA) and the PSPM method of the present invention using realized splitting functions (splitting frequency & daughter particle distribution). These functions describe droplet breakage in a turbulent liquid-liquid dispersion taking into account the effect of the dispersion physical properties and the energy dissipation. It is obvious that 35 primary particles are enough to predict accurately the shape of the distribution as compared with the CDA.

Moreover, the prediction of shape of the distribution using the PSPM is much better (close to the fine grid solution) than that predicted by the CDA using only 10 primary particles. On contrary to the sectional methods, since the large increase in the number of primary particles has negligible effect on the prediction of integral quantities, using small number of primary particles to infer about the shape of the distribution is usually sufficient.

The third example is for particle aggregation in batch stirred vessel where the analytical solution is reported by Seinfeld (1972) for sum aggregation frequency (ω=d³+d^{′3}) and the exponential (with respect to particle volume) initial condition.

FIG. (4a) shows the predicted average number density using 25 primary particles and two secondary particles. It is clear how accurately the PSPM predicts the aggregation events even in the sharp parts of the solution. Also, the first four low-order moments are accurately predicted with the third moment showing an exact mass conservation. It should be emphasized again that the rapid increase in the number of primary particles is not a condition implied by the PSPM if only integral properties of the distribution are desired which is the usual case. A few number of primary particles (depending on the sharpness of the distribution) is usually enough to get an idea about the shape of the distribution, while maintaining high accuracy in terms of the integrap quantities.

So, the computational load of the PSPM may be dependent on the accuracy and details needed by the user. Since it reduces directly to the standard QMOM by setting the number of primary particles equals to one, the computational load is expected to be minimum; however, at the expense of destroying the shape of the distribution.

It is clear that the CPU time grows in quadratic form as a function of primary particles as shown in FIG. (4b). This quadratic form seems to persist even if the number of secondary particles is increased to 3, which is not a requirement of the PSPM.

The above description is not intended to limit the meaning of the words used in the following claim that define the invention. Persons of ordinary skill in the art will understand that a variety of other designs still falling within the scope of the following claims may be envisioned and used. It is contemplated that future modifications in structure, function, or result will exist that are not substantial changes and that all such insubstantial changes in what is claimed are intended to be covered by the claims.

I claim:

1. A method for simulating and modeling the distribution of discrete systems, the discrete systems having at least one internal property, the internal property having a range, the method comprising the steps of:
a. Dividing the internal property into a number of units;
b. Storing information about the internal property of each unit;
c. Generating information about the variation of the internal property in each unit;
d. Generating information about the internal property of the population in each unit; and
e. Generating information to approximately recover the internal property of the population of the discrete systems.

2. The method of claim 1 wherein the internal property includes an initial density.

3. The method of claim 1 wherein the step of dividing the internal property includes the step of dividing the internal property into a finite number of bins, wherein each bin having a finite population and wherein the finite population having a certain initial finite.

4. The method of claim 1 wherein the step of storing information includes the step of generating a finite low-order local moments in each unit.

5. The method of claim 1 wherein the step of generating information about the variation of the internal property in each unit includes the step of generating secondary particles in each unit.

6. The method of claim 1 wherein the step of generating information about the internal property of the population in each unit includes the step of generating a primary article for each unit.

7. The method of claim 1 wherein the internal property is continuous.

8. A method for simulating and modeling the distribution of a discrete system, the discrete system having an initial density with respect to a discrete internal property, the internal property having a range, the method comprising the steps of:
a. Dividing the internal property into a finite number of bins, each bin having a finite population, the finite population having a certain initial finite, b. Generating a finite low-order local moment in each bin in order to store information about the density of each bin,
c. Generating finite number of secondary particles in each bin using the finite low-order local moment in each bin, the secondary particles extracting information about the variation of density in each bin from the moment in each bin, and
d. Generating a primary particle for each bin in order to approximate the population density of each bin, the primary particles are generated using the secondary particles in each bin, and
e. Combining the primary particles in order to approximately recover the density of the population of the discrete system.
